(19) United States
(12) Patent Application Publication
(10) Pub. No.: US 2014/0283603 A1
(43) Pub. Date: Sep. 25, 2014

(54) Micromechanical Element, Component Having a Micromechanical Element, and Method for Producing a Component

(71) Applicant: Continental Teves AG & Co. OHG, Frankfurt (DE)

(72) Inventors: Stefan Günthner, Frankfurt (DE); Bernhard Schmid, Friedberg (DE)

(21) Appl. No.: 14/355,428

(22) PCT Filed: Nov. 2, 2012
(86) PCT No.: PCT/EP2012/071724

§ 371 Date: Apr. 30, 2014

(30) Foreign Application Priority Data
Nov. 3, 2011 (DE) 10 2011 085 727.3

(51) Int. Cl. G01P 15/08

(52) U.S. Cl. CPC G01P 15/0888
USPC 73/514.02; 29/592.1

(57) ABSTRACT

A micromechanical element (123a) having a plurality of individual sensor elements (1′a, 2′a, 3′a, 23a), wherein a first physical measurement variable can be measured with a first individual sensor element (1′a, 2′a, 3′a, 23a) and a second physical measurement variable can be measured with a second individual sensor element (1′a, 2′a, 3′a, 23a). A component is provided having at least one control electronics unit (1′b, 2′b, 3′b) which can be connected electrically to the micromechanical element (123a); wherein the micromechanical element (123a) and the control electronics unit (1′b, 2′b, 3′b) are arranged in a common housing (123c). A method for producing the component is further described.

### CROSS REFERENCE TO RELATED APPLICATIONS

This application claims priority to German Patent Application No. 10 2011 085 727.3, filed on Nov. 3, 2011 and PCT/EP2012/071724, filed Nov. 2, 2012.

### FIELD OF THE INVENTION

The invention relates to a micromechanical element, a component having a micromechanical element and a method for producing a component.

### BACKGROUND

In active and passive safety systems of contemporary automobiles, numerous sensor information items such as the wheel speed, steering lock, acceleration values and rotational speed values are required. For example, an airbag function uses acceleration information items along a longitudinal axis and along a transverse axis of the vehicle with a measurement range up to 500-1000 m/s². In contrast, for the electronic stability programme, acceleration sensor information items in the range up to 20 m/s² are required in addition to the measurement of the rotational speed about the vertical axis of the vehicle. In this context, separate sensors are conventionally used for measuring the acceleration for different measurement ranges.

A further procedure proposes integrating a plurality of sensors to form one unit. Arrangements with sensor integration on an individual chip are already known. EP 2 081 030 A2 describes a combination of an acceleration sensor with a rotational rate sensor. WO 2008/026331 A1 presents an acceleration sensor with an extended measurement range.

However, until now it has been problematic to carry out measurements of various measurement variables such as rotational speed and acceleration with a single micromechanical element.

The invention is based on the object of proposing solutions in order to be able to make available different physical measurement variables with a single device.

The object is achieved by means of the features described herein. Preferred developments of the invention are the subject matter of the dependent claims.

The invention is therefore based on the concept of making available a micromechanical element, a component having a micromechanical element and a method for producing the component. In this context, the micromechanical element, which can be part of a component, has a plurality of individual sensor elements, wherein at least two individual sensor elements of a micromechanical element are arranged in a housing of a component.

Individual sensor elements can be embodied as sensors such as, for example, rotational speed sensors and acceleration sensors. With the micromechanical element according to the invention it is possible to make available sensors for measuring rotational speed values and acceleration values with an extended measurement range. By integrating a plurality of individual sensor elements inside one micromechanical element it is possible to measure over time different physical measurement variables such as acceleration, velocity, rotational rate, pressure, temperature and angle, such as the angle of inclination.

A combination of individual sensor elements which can register physical measurement variables in different ranges, for example as an acceleration sensor unit, is also suitable for being arranged inside the micromechanical element according to the invention. Such micromechanical elements extend the measurement range of the individual sensor elements. This is advantageous, in particular, when measuring an acceleration in vehicles. In this context, low acceleration values and high acceleration values can be measured with similar precision using a single micromechanical element inside one component. Control units or control electronics units, which are also arranged in the component, can further process the detected measurement values.

It is therefore possible to use a single component or sensor to make available the measurement of rotational speed values and acceleration values with an extended measurement range. It is possible to make available integration of elements on a single electromechanical element or chip by, for example, integrating different micromechanical structures at different gas pressures on a chip in order to carry out different measurement tasks. In this context it is possible to make available different requirements using different adjustable pressures in the chip.

It is also possible to use the sensors according to the invention for measuring the longitudinal acceleration and transverse acceleration of a vehicle in the lower measurement range and in the high measurement range, as well as to detect the rotational speed about the vertical axis of a vehicle. Integrating the sensors inside one component allows a saving in terms of space and costs.

In addition it is advantageous to combine rotational rate sensors and acceleration sensors with one another on one unit in order to make available a single part for different measurement tasks. This is possible since the measurements of the rotational speed and acceleration can be based on similar physical principles, which permits all the sensors to be integrated in a single micromechanical element.

It is also advantageous if production processes of the acceleration sensors and of the rotational rate sensors are made similar, with the result that harmonizing the processes or method steps during the production of the two sensor types permits the same technology platform to be used.

In addition it is advantageous that the integration constitutes a reduction in the costs for the design technology and connection technology since fewer elements have to be processed. It is also possible to produce a combined micromechanical element more cost-effectively since there can be a saving in terms of structures such as, for example, frames. Finally, the space required for a single element is smaller compared to an arrangement with a plurality of elements.

Crash situations can also be detected in good time if strong and abrupt braking, which occurs in the low acceleration range, is detected and implemented in an airbag triggering method. Owing to differences in signal transit time and phases between acceleration sensors which operate separately and are physically independent it is possible for disadvantages to occur during the configuration of the triggering method. These disadvantages can now be overcome by using the proposed arrangements.

Developments of the invention may be method steps which implement the features of the specified components described herein.

### BRIEF DESCRIPTION OF THE DRAWINGS

The properties, features and advantages of this invention which are described above as well as the way in which they are achieved become clearer and more easily understandable in conjunction with the following description of the exemplary embodiments which are explained in more detail in conjunction with the drawings, in which:

FIG. 1 shows a conventional arrangement of components;

FIG. 2 shows a first exemplary embodiment of an arrangement according to the invention; and

FIG. 3 shows a second exemplary embodiment of an arrangement according to the invention.

In this context, the same reference symbols are used for identical or similar elements in the figures.

### DETAILED DESCRIPTION OF THE INVENTION

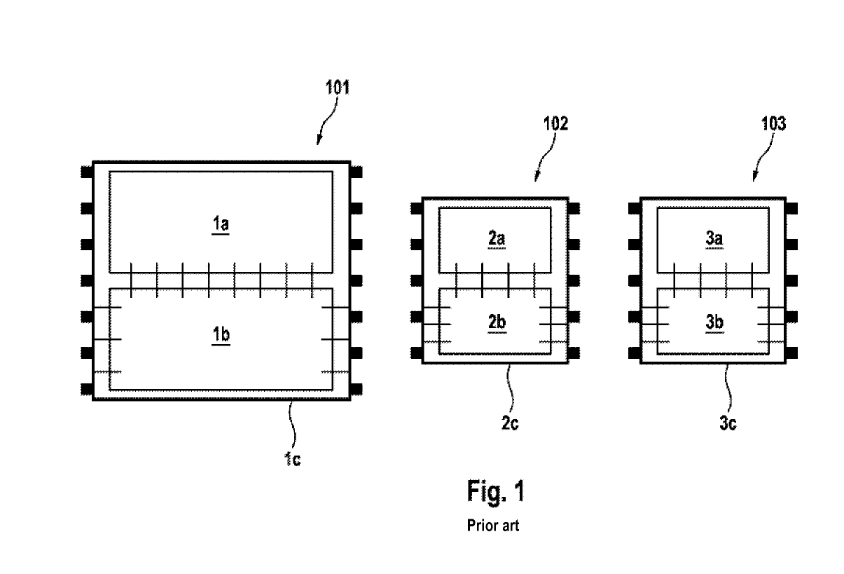

FIG. 1 shows a conventional arrangement of components 101, 102, 103. In the case of micromechanical sensors, in this context a micromechanical rotational rate sensor 1a is usually arranged together with a control electronics unit 1b in a common housing 1c. Likewise, an acceleration sensor element with a low measurement range 2a and an acceleration sensor element with a high measurement range 3a and corresponding control electronics for the low measurement range 2b and for the high measurement range 3b are packed and respectively arranged in a common housing 2c or 3c. Three individual components 101, 102, 103 are therefore used for three measurement tasks, specifically the measurement of a low acceleration, of a high acceleration and of a rotational rate, in which individual components 101, 102, 103 micromechanical elements 1a, 1b and 2a, 2b and 3a, 3b are respectively located.

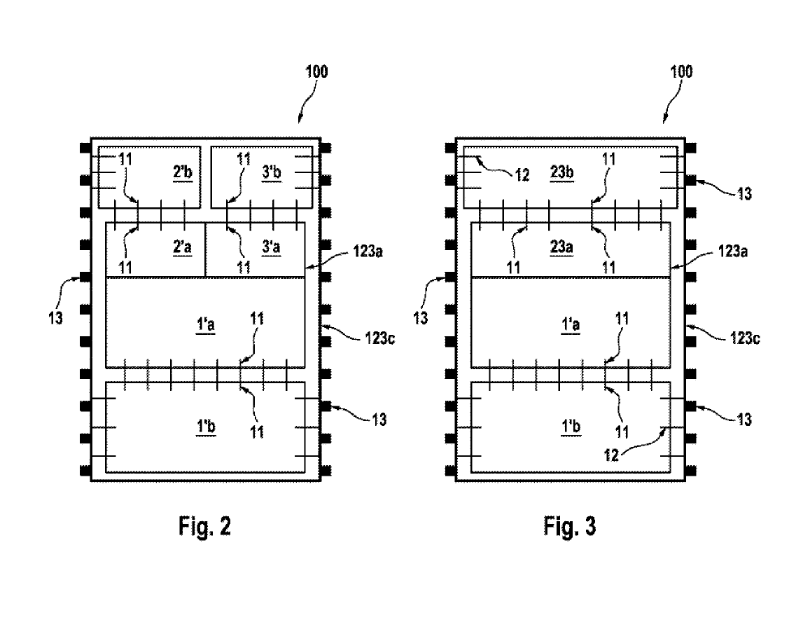

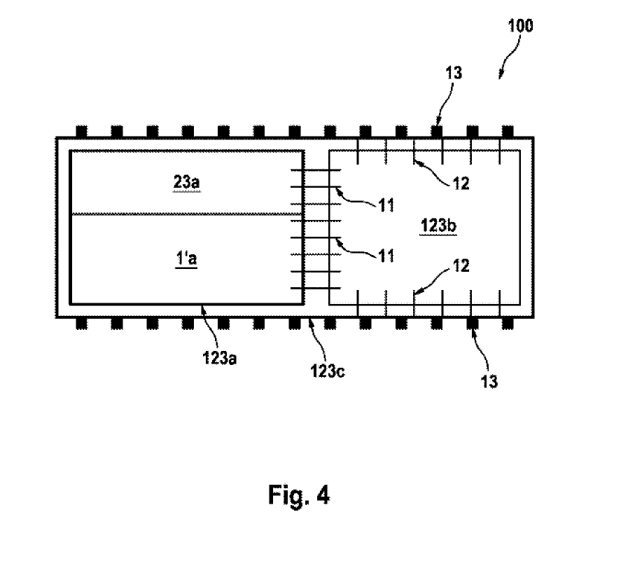

FIG. 2 shows a first exemplary embodiment of an arrangement according to the invention of a component 100. In this context, a single micromechanical element 123a, here a sensor element in a chip, includes a plurality of individual elements 1′a, 2′a, 3′a. The individual elements 1′a, 2′a, 3′a here can occupy regions within the common chip 123a which are hermetically separated from one another and which can enclose different pressures. The respective control electronics are arranged on separate units 1′b, 2′b, 3′b and are accommodated with the sensor element 123a in a common housing 123c. In this way, acceleration measurement over a large measurement range can be covered both with low and high acceleration values such as, for example, from approximately 1 m/s² to approximately 1000 m/s². It is also possible for a single element to cover such a measurement range by virtue of the fact that an acceleration sensor unit 23a is made available as shown in FIGS. 3 and 4.

FIG. 3 shows a second exemplary embodiment of an arrangement according to the invention. FIG. 3 shows a micromechanical element 123a having a rotational rate sensor 1′a and having a combined acceleration sensor unit 23a. The individual elements 1′a and 23a here can occupy regions within the common chip 123a which are hermetically separated from one another and which enclose different pressures. The respective control electronics are located on separate units 1′b, 23b and are accommodated with the sensor element 123a in a common housing 123c.

FIG. 4 shows a third exemplary embodiment of an arrangement according to the invention. The component 100 has a combination of a rotational rate sensor 1′a with a combined acceleration sensor unit 23a, for example a combination 23a for measuring high acceleration values and low acceleration values in one unit. The individual elements 1′a and 23a can occupy regions within the common chip 123a which are hermetically separated from one another and which enclose different pressures, in order in this way to make available different response characteristics. The control electronics for all the individual elements 23a, 1′a are located on a single unit 123b and accommodated with the sensor element 123a in a common housing 123c of the component 100.

In FIGS. 2, 3, and 4, at least one micromechanical element 123a and at least one control device 1′b, 2′b, 3′b, 23b, 123b are respectively arranged inside the housing 123c of the component 100. The micromechanical element 123a has at least two individual sensor elements 1′a, 2′a, 3′a, 23a. Each individual sensor element 1′a, 2′a, 3′a, 23a can be respectively assigned one control electronics unit 1′b, 2′b, 3′b, 23b, 123b. In this context, the micromechanical element 123a is available for at least two measurement tasks, and at least one control device 1′b, 2′b, 3′b, 23b, 123b is therefore connected to the micromechanical element 123a.

The micromechanical element 123a and the control devices 1′b, 2′b, 3′b, 23b, 123b are each connected to one another electrically via a first connection geometry 11. The control devices 1′b, 2′b, 3′b, 23b, 123b each have a second connection geometry 12 which is connected electrically to a third connection geometry 13 of the component 100. The component 100 can be placed in contact with external electrical wiring by the third connection geometry 13.

While the above description constitutes the preferred embodiment of the present invention, it will be appreciated that the invention is susceptible to modification, variation and change without departing from the proper scope and fair meaning of the accompanying claims.

1. A micromechanical element comprising first and second individual sensor elements, wherein the first physical measurement variable can be measured with the first individual sensor element and a second physical measurement variable can be measured with the second individual sensor element.

2. The micromechanical element as claimed in claim 1, further comprising wherein the first physical measurement variable and the second physical measurement variable differ from one another.

3. The micromechanical element as claimed in claim 1, further comprising wherein the first and the second physical measurement is at least one of a group of measurement variables composed of acceleration, velocity, rotational rate, pressure, temperature, and angle.

4. The micromechanical element as claimed in claim 1, further comprising wherein the first individual sensor element is arranged in a first region of the micromechanical element, and the second individual sensor element is arranged in a second region of the micromechanical element, wherein the first region and the second region are separated from one another hermetically.

5. The micromechanical element as claimed in claim 4, further comprising wherein the first region has a first pressure and the second region has a second pressure, and wherein the first pressure and the second pressure are different.

6. A component for measuring at least two physical measurement variables comprising:
a micromechanical element having first and second individual sensor elements, wherein a first physical measurement variable can be measured with the first individual sensor element and the second physical measurement variable can be measured with the second individual sensor element;
at least one control electronics unit adapted to be connected electrically to the micromechanical element; and
wherein the micromechanical element and the control electronics unit are arranged in a common housing.

7. The component as claimed in claim 6, further comprising wherein at least one of the first and the second individual sensor elements is connected electrically to the control electronics unit inside the housing via a first connection geometry.

8. The component as claimed in claim 7, further comprising wherein the control electronics unit has a second connection geometry which is connected electrically to a third connection geometry of the component.

9. The component as claimed in claim 6, further comprising wherein the micromechanical element is arranged geometrically centrally between a first control electronics unit and a second control electronics unit.

10. A method for manufacturing a component comprising:
making available providing a component having a micromechanical element (123a) having a plurality of first and second individual sensor elements, wherein a first physical measurement variable can be measured with the first individual sensor element and a second physical measurement variable can be measured with the second individual sensor element;
providing at least one control electronics unit;
electrically connecting the micromechanical element to the control electronics unit; and
arranging the micromechanical element and the control electronics unit in a common housing.

11. The component as claimed in claim 6, further comprising wherein the first physical measurement variable and the second physical measurement variable differ from one another.

12. The component as claimed in claim 6, further comprising wherein at least one of the first and the second physical measurement variables is from the group of measurement variables composed of acceleration, velocity, rotational rate, pressure, temperature, and angle.

13. The component as claimed in claim 6 further comprising wherein the first individual sensor element is arranged in a first region of the micromechanical element and the second individual sensor element is arranged in a second region of the micromechanical element, wherein the first region and the second region are separated from one another hermetically.

14. The component as claimed in claim 13, further comprising wherein the first region has a first pressure and the second region has a second pressure, and wherein the first pressure and the second pressure are different.

15. The method of manufacturing a component as claimed in claim 10, further comprising wherein the first physical measurement variable and the second physical measurement variable differ from one another.

16. The method of manufacturing a component as claimed in claim 10, further comprising wherein at least one of the first and the second physical measurement variables is from the group of measurement variables composed of acceleration, velocity, rotational rate, pressure, temperature, and angle.

17. The method of manufacturing a component as claimed in claim 10 further comprising arranging the first individual sensor element in a first region of the micromechanical element and arranging the second individual sensor element in a second region of the micromechanical and separating the first region and the second region from one another hermetically.

18. The method of manufacturing a component as claimed in claim 17, further comprising providing the first region with a first pressure and providing the second region with a second pressure, and wherein the first pressure and the second pressure are different.
